(19) United States
(12) Patent Application Publication
(10) Pub. No.: US 2002/0093146 A1
(43) Pub. Date: Jul. 18, 2002

(54) Pressure relief arrangement for a housing

(76) Inventors: John C. Opfer, Chicago, IL (US); Andrew C. Shum, Des Plaines, IL (US)

Correspondence Address: James V. Lapacek, S & C Electric Co., 6601 N. Ridge Blvd., Chicago, IL, 60626, US

(21) Appl. No.: 10/017,260

(22) Filed: Dec. 18, 2001

Related U.S. Application Data
(60) Provisional application No. 60/258,085, filed on Dec. 27, 2000.

(51) Int. Cl. F16J 15/02

(52) U.S. Cl. 277/630

(57) ABSTRACT

A pressure relief arrangement is provided for a housing for a circuit interrupter or the like that utilizes rupture disc members that are loaded in shear in response to overpressures. Fastening members, e.g. bolts retain a cover or end plate with respect to an end flange of the housing and apply force to the rupture disc members. Upon predetermined overpressure conditions within the interior of the housing relative to the exterior, the pressure relief arrangement operates to separate the cover and the end flange thus releasing the seal therebetween and venting the overpressure between the cover and the end flange. The rupture disc member is fabricated to become disintegral under the predetermined overpressure conditions so as to release the cover. Each rupture disc is loaded in shear and is fabricated with predetermined portions of reduced cross section to focus the applied force. When the force exceeds the shear strength of the material, one or more of the rupture disc members break, the remaining load on the other rupture disc members increasing and causing them to break successively. Specifically, the each rupture disc member includes reduced section portions to appropriately shear the rupture disc member under the loading of the predetermined overpressure conditions.

This application claims the benefit of U.S. Provisional Application No. 60,258,085 filed on Dec. 27, 2000 in the names of John C. Opfer and Andrew C. Shum.

### BACKGROUND OF THE INVENTION

1. Field of the Invention

The present invention relates generally to the field of pressure relief for housings, especially for protective devices and systems for electrical power transmission and distribution systems, and more particularly to a pressure relief arrangement for a circuit interrupter that responds to relieve overpressures within the circuit interrupter.

2. Description of the Related Art

Various pressure relief arrangements are know for operating to relieve overpressures including overpressures occurring in electrical protective devices such as fuses, circuit interrupters and circuit breakers used in the electrical power field. One approach provides a weakened housing portion that ruptures or detaches in response to predetermined overpressures. Another approach utilizes a pressure relief valve. Still another arrangement, shown in U.S. Pat. No. 5,100,157,utilizes the displacement of a sealing member. In U.S. Pat. No. 4,583,750,a member that applies sealing force is acted upon by overpressures.

While the prior art arrangements may be useful to provide overpressure relief, these prior arrangements are generally complex and require additional and rather specialized components.

### SUMMARY OF THE INVENTION

Accordingly, it is a principal object of the present invention to provide a pressure relief arrangement for a housing that utilizes rupture members that are loaded in shear in response to overpressure.

These and other objects of the present invention are efficiently achieved by the provision of a pressure relief arrangement for a housing for a circuit interrupter or the like that utilizes rupture disc members that are loaded in shear in response to overpressures. Fastening members, e.g. bolts retain a cover or end plate with respect to an end flange of the housing and apply force to the rupture disc members. Upon predetermined overpressure conditions within the interior of the housing relative to the exterior, the pressure relief arrangement operates to separate the cover and the end flange thus releasing the seal therebetween and venting the overpressure between the cover and the end flange. The rupture disc member is fabricated to become disintegral under the predetermined overpressure conditions so as to release the cover. Each rupture disc is loaded in shear and is fabricated with predetermined portions of reduced cross section to focus the applied force. When the force exceeds the shear strength of the material, one or more of the rupture disc members break, the remaining load on the other rupture disc members increasing and causing them to break successively. Specifically, the each rupture disc member includes reduced section portions to appropriately shear the rupture disc member under the loading of the predetermined overpressure conditions.

### BRIEF DESCRIPTION OF THE DRAWING

The invention, both as to its organization and method of operation, together with further objects and advantages thereof, will best be understood by reference to the specification taken in conjunction with the accompanying drawing in which:

FIG. 1 is a front elevational view, partly in section, of a portion of a housing and the pressure relief arrangement of the present invention;

FIG. 2 is an elevational view, partly in section, of a portion of an end flange member of the housing of FIG. 1;

FIG. 3 is a sectional view of a rupture disc member of the pressure relief arrangement of FIG. 1;

FIGS. 4 and 5 are respective partial, enlarged views of portions of the rupture disc member as indicated in FIG. 3;

FIG. 6 is sectional view of a bushing member of the pressure relief arrangement of FIG. 1;

FIG. 7 is a partial, bottom plan view of portions of the end flange of FIG. 2;

FIG. 8 is a sectional view of an alignment disc of the overpressure relief arrangement of FIG. 1;

FIG. 9 is a front elevational view, partly in section, of a portion of a housing and an alternate embodiment of the pressure relief arrangement of the present invention;

FIG. 10 is an enlarged view of a portion of the arrangement of FIG. 9;

FIG. 11 is a front elevational view, partly in section, of the pressure relief arrangement of FIG. 9 illustrating operation after overpressure relief; and

FIG. 12 is an enlarged view of a portion of the arrangement of FIG. 11.

### DETAILED DESCRIPTION

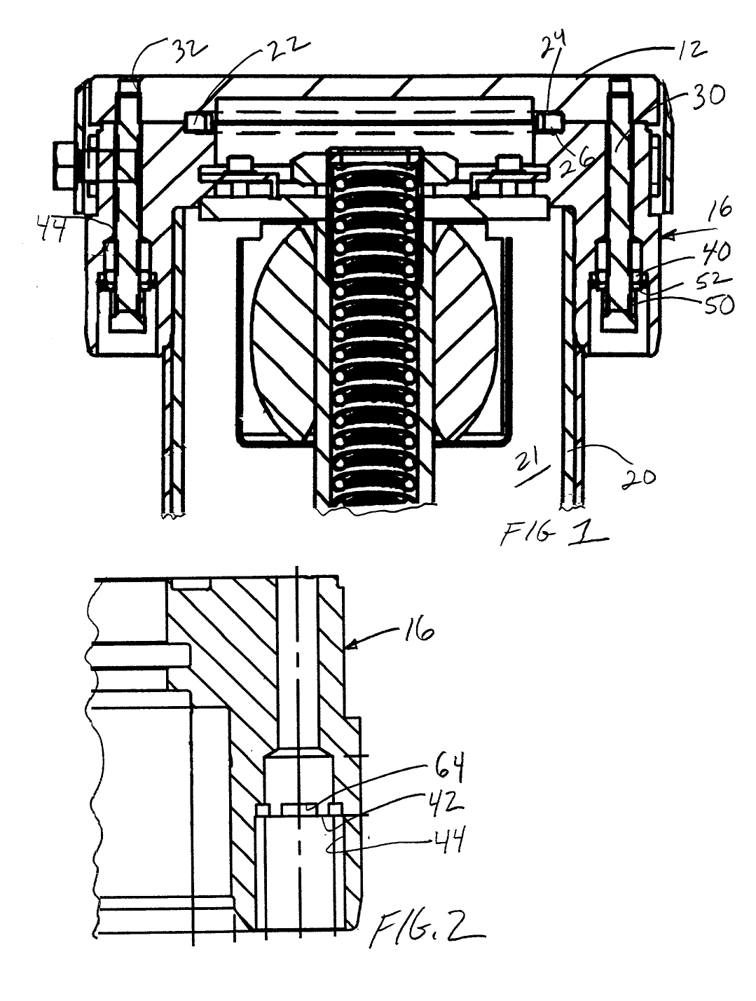

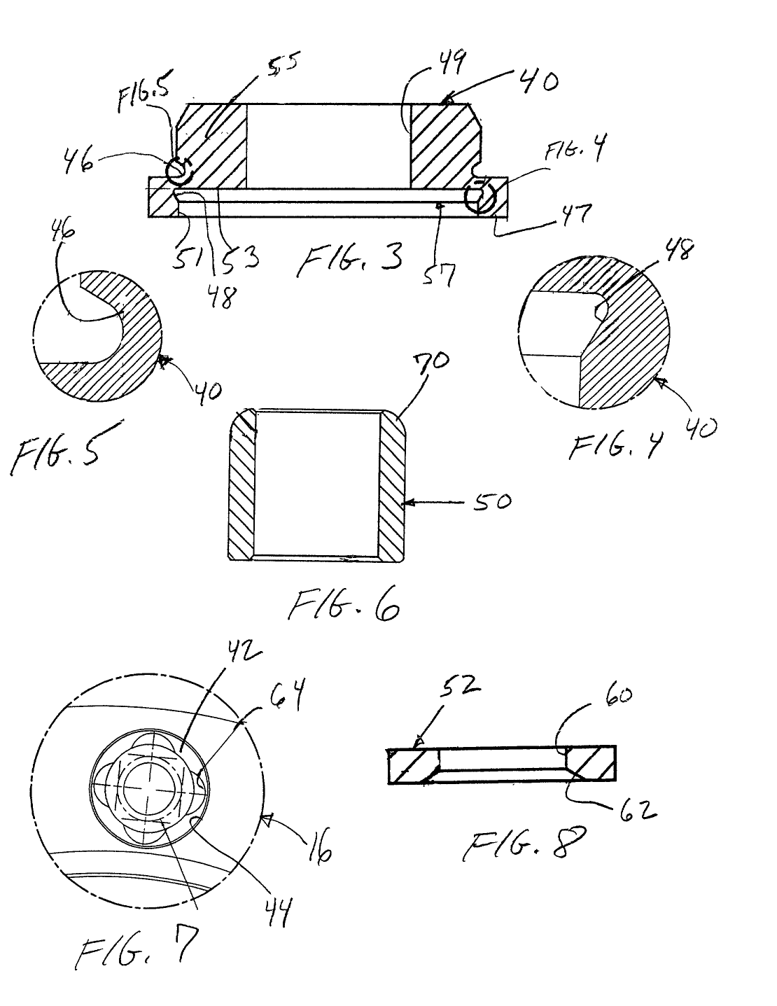

Referring now to FIGS. 1-8, the pressure relief arrangement 10 of the present invention is provided as a separate function to the supporting function between an illustrative end plate or cover 12 and an end flange 16 of a housing generally referred to at 20. A seal member 22 is provided within respective sealing grooves 24, 26 of the cover 12 and the end flange 16. Fastening members, e.g. bolts 30 retain the cover 12 with respect to the end flange 16. Upon predetermined overpressure conditions within the interior 21 of the housing 20 relative to the exterior, the pressure relief arrangement 10 operates to separate the cover 12 and the end flange 16 thus releasing the seal therebetween and venting the overpressure between the cover 12 and the end flange 16.

Considering now the specifics of the illustrative embodiment of FIGS. 1-8, the bolts 30 are threaded into threaded receiving passages 32 within the cover 12. Each of the bolts 30 is assembled to apply force to a respective rupture disc member 40 that is retained against a first shoulder 42 (FIG. 2) formed within a passage 44 of the end flange 16. A bushing member 50 is provided between the bolt 30 and the rupture disc member 40 to provide uniform loading to the rupture disc member 40 and to accommodate any misalignment between the various component parts. In a preferred embodiment, an alignment disc 52 is also provided between the bushing member 50 and the rupture disc member 40 to assist in uniform application of force to the rupture disc member 40. The rupture disc member 40 is fabricated to become disintegral under the predetermined overpressure conditions so as to release the cover 12.

In the illustrative embodiment of FIGS. 3-5, the rupture disc 40 is loaded in shear and is fabricated with predetermined portions of reduced cross section to focus the applied force. When the force exceeds the shear strength of the material, one or more of the rupture disc members 40 break, the remaining load on the other rupture disc members 40 increasing and causing them to break successively. Specifically, the rupture disc member 40 includes reduced section portions 46 and 48 (FIGS. 3-5) to appropriately shear the rupture disc member 40 under the loading of the predetermined overpressure conditions, e.g. at a much lower load than without the reduced section portions. The rupture disc member 40 is generally a ring with a widened rim portion 47 that engages and cooperates with the shoulder 42 of the passage 44. The rupture disc member 40 also includes a central body portion 55 having a central bore 49 formed therethrough for passage of the bolt 30. The widened rim portion 49 includes a bored portion 57 to define a shoulder wall 51 that extends to the top central portion 53 of the central body portion 55. The widened rim portion 49 is dimensioned to receive the alignment disc 52 within the bored portion 57. Referring to FIG. 8, the alignment disc 52 includes a central aperture 60 and a widened circumferential tapered portion 62 that is dimensioned to cooperate with the bushing 50. Specifically, and with reference to FIG. 6, the bushing 50 includes a conical leading edge portion 70 that cooperates with the tapered portion 62 of the alignment disc 52.

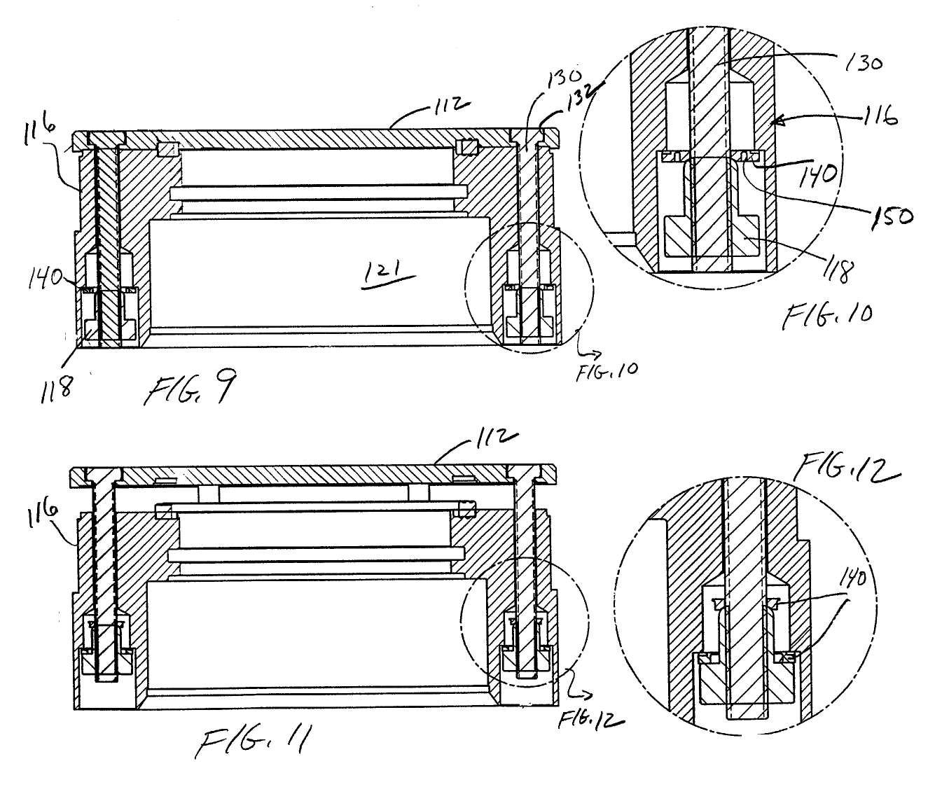

In a specific embodiment where the bolts 30 are assembled through the cover 12 and secured with nuts as shown in FIGS. 9-12, to provide for water egress and the like from the passage 44, as seen in FIGS. 2 and 7, communicating passage features 64 are provided at the shoulder 42.

Referring now to FIGS. 9-12 and considering an alternate embodiment of the present invention, a pressure relief arrangement 100 according to the present invention includes bolts 130 that are inserted through apertures 132 in a cover 112 and extend through passages 134 in an end flange 116. A rupture disc member 140, seen best in FIG. 10, is positioned over the bolt 130 and a nut 118 secures the bolt 130. The rupture disc member 140 is retained against a shoulder 144 of the end flange 116. When the internal pressure relative to external pressure exceeds a predetermined value, the rupture disc member 140 is sheared as shown in FIGS. 11 and 12 and the bolt 130 moves upward in FIGS. 10 and 11 to release the cover 112 and vent the interior 121. As best seen in FIG. 10, the rupture disc member 140 is formed with a radially uniform reduced cross section, e.g. as shown in FIG. 10, via the circumferential groove 150.

It should be noted that the pressure relief arrangements 10 and 100 of the present invention are extremely reliable and reproducible, the only variable being the shear strength of the rupture disc members 40 and 140. Thus, only the rupture disc members 40 and 140 need to be destructively tested to verify appropriate functioning and compliance. It should also be noted that it is desirable to fabricate the bolts 30 and the cover 12 or the bolts 130 and the cover 112 of materials with similar thermal expansion coefficients so that the bolts change in length with temperature at the same rate as the top cover.

While there have been illustrated and described various embodiments of the present invention, it will be apparent that various changes and modifications will occur to those skilled in the art. Accordingly, it is intended in the appended claims to cover all such changes and modifications that fall within the true spirit and scope of the present invention.

1. A pressure relief arrangement for a housing including two housing portions comprising:
first means for applying compressive sealing force between the two housing portions; and
second means operative with said first means for responding to overpressure within the housing, said second means comprising at least one member being loaded in shear and becoming disintegral in response to the overpressure exceeding a predetermined value.

2. The pressure relief arrangement of claim 1 wherein said first means applies force to said second means, overpressure within the housing acting to increase the force on said second means.

3. The pressure relief arrangement of claim 1 wherein said second means comprises a plurality of rupture disc members having predetermined portions of reduced cross section.

4. The pressure relief arrangement of claim 3 wherein said first means and said rupture disc members are dimensioned and assembled to focus applied forces in a predetermined manner to said rupture disc members.

5. The pressure relief arrangement of claim 1 wherein said first means includes third means for focusing applied forces to said second means.

6. The pressure relief arrangement of claim 5 wherein said first means further comprised fourth means for aligning said first, second and third means.

7. A pressure relief arrangement for a housing comprising:
first and second housing portions, means for applying compressive sealing force between the two housing portions and means for responding to overpressure within the housing being loaded in shear and becoming disintegral in response to the overpressure exceeding a predetermined value.
